(19) United States
(12) Patent Application Publication
(10) Pub. No.: US 2020/0263067 A1
(43) Pub. Date: Aug. 20, 2020

(54) DEICER COMPOSITION

(71) Applicant: Cargill, Incorporated, Wayzata, MN (US)

(72) Inventor: Robert Scott KOEFOD, Maple Grove, MN (US)

(73) Assignee: Cargill, Incorporated, Wayzata, MN (US)

(21) Appl. No.: 16/067,877

(22) PCT Filed: Jan. 6, 2017
(86) PCT No.: PCT/US2017/012458

§ 371 Date: Jul. 3, 2018

Related U.S. Application Data
(60) Provisional application No. 62/275,350, filed on Jan. 6, 2016.

(51) Int. Cl. C09K 3/18

(52) U.S. Cl. CPC C09K 3/185

(57) ABSTRACT

Deicer compositions are disclosed. In one aspect of the disclosure, the deicer composition includes a pre-wetting composition. The pre-wetting composition includes a liquid deicing salt. The pre-wetting composition also includes a liquid corrosion inhibitor comprising at least one aldonic or aldaric acid or salt of an aldonic or aldaric acid chosen from D-erythronic acid, D-gulonic acid, glucaric acid, gluconic acid and L-mannonic acid. The pre-wetting composition also includes a liquid leaching inhibitor comprising at least one of soy flour, dextrin, starch, gum Arabic, guar gum, xanthan gum, gum ghatti, gum karaya, locust bean gum, carageenan gum, sodium alginate, partially hydrolyzed polyacrylamide, bentonite, attapulgite, montmorillonite, hectorite, kaolin, hydroxyethylcellulose, viscosifying, clays. The deicer composition also includes a solid composition. The solid composition includes a solid deicing salt. The solid composition also includes a solid corrosion inhibitor including a phosphate salt.

This application claims the benefit of U.S. Provisional Application Ser. No. 62/275,350, filed Jan. 6, 2016, entitled “Deicer Composition,” which application is incorporated herein by reference in its entirety.

### TECHNICAL FIELD

The present disclosure relates generally to deicer compositions. Aspects of the disclosure are particularly directed to a deicer composition providing suitable corrosion inhibition also referred to as anti-corrosion.

### BACKGROUND

Deicer compositions are known. For example, U.S. Patent Application Publication No. 2014/0319408 titled Environmentally-Friendly Improved Deicer Compositions by inventor Robert Scott Koefod and assigned to Cargill, Incorporated discloses a deicer composition. Such deicer composition is disclosed to include a viscosifying additive, i.e. xanthan gum and hyoxyethyl cellulose, to increase its viscosity, and a corrosion inhibitor, i.e. gluconate.

Other known deicer compositions are disclosed, for example, in U.S. Pat. No. 7,658,861 titled Corrosion-Inhibiting Deicer Composition by inventor Robert Scott Koefod and assigned to Cargill, Incorporated. The '861 patent discloses a deicer composition having a corrosion inhibitor, i.e. salts of gluconic acid.

Other known deicer compositions are disclosed, for example, in U.S. Pat. No. 8,137,578 titled Leaching Resistant Pre-Wetted Deicer Composition by inventor Robert Scott Koefod and assigned to Cargill, Incorporated. The '578 patent discloses a deicer composition having a leaching inhibitor, i.e. xanthan gum. The '578 patent also discloses a corrosion inhibitor, specifically phosphate salts such as diammonium phosphate.

Other known deicer compositions are disclosed, for example, in U.S. Pat. No. 6,800,217 titled Deicer and Pre-Wetting Agent by inventor Robert Scott Koefod et al. and assigned to Cargill, Incorporated, and in U.S. Patent Publication No. 2012/0193569 titled Deicer Composition by inventor Robert Scott Koefod and assigned to Cargill, Incorporated.

The prior art solutions lack a deicer composition having suitable corrosion inhibitor properties.

### SUMMARY

In one aspect, a deicer composition is disclosed. The deicer composition includes a pre-wetting composition. The pre-wetting composition includes a liquid deicing salt. The pre-wetting composition also includes a liquid corrosion inhibitor comprising at least one aldonic or aldaric acid or salt of an aldonic or aldaric acid chosen from D-erythronic acid, D-gulonic acid, glucaric acid, gluconic acid and L-mannonic acid. The pre-wetting composition also includes a liquid leaching inhibitor comprising at least one of soy flour, dextrin, starch, gum Arabic, guar gum, xanthan gum, gum ghatti, gum karaya, locust bean gum, carageenan gum, sodium alginate, partially hydrolyzed polyacrylamide, bentonite, attapulgite, montmorillonite, hectorite, kaolin, hydroxyethylcellulose, and viscosifying clays. The deicer composition also includes a solid composition. The solid composition includes a solid deicing salt. The solid composition also includes a solid corrosion inhibitor including a phosphate salt.

In another aspect, a deicer composition is disclosed. The deicer composition includes a liquid pre-wetting composition present at a concentration of 1.0 to 10.0 percent by weight of the deicer composition. The liquid pre-wetting composition includes a deicing salt comprising magnesium chloride present at a concentration of 10 to 35 percent by weight of the pre-wetting composition. The liquid pre-wetting composition also includes a corrosion inhibitor comprising sodium gluconate present at a concentration of 0.1 to 5.0 percent by weight of the pre-wetting composition. The a liquid pre-wetting composition also includes a leaching inhibitor comprising xanthan gum present at a concentration of 0.05 to 2.0 percent by weight of the pre-wetting composition. The liquid pre-wetting composition also optionally includes a radiation absorber comprising present at a concentration of 0.05 to 1.0 percent by weight of the pre-wetting composition. The deicer composition also includes a solid deicing salt. The solid deicing salt includes a first solid deicing salt comprising sodium chloride present at a concentration of 65 to 90 percent by weight of the deicer composition. The solid deicing salt also includes a second solid deicing salt comprising magnesium chloride hydrate present at a concentration of 1.0 to 25 percent by weight of the deicer composition. The solid deicing salt includes a solid corrosion inhibitor comprising diammonium phosphate present at a concentration of 0.5 to 5.0 percent by weight of the deicer composition.

In yet another aspect, a deicer composition is disclosed. The deicer composition includes a liquid pre-wetting composition present at a concentration of 1.0 to 10.0 percent by weight of the deicer composition. The liquid pre-wetting composition includes a deicing salt comprising magnesium chloride present at a concentration of 10 to 35 percent by weight of the pre-wetting composition. The liquid pre-wetting composition also includes a first corrosion inhibitor comprising sodium gluconate present at a concentration of 0.1 to 5.0 percent by weight of the pre-wetting composition. The liquid pre-wetting composition also includes a leaching inhibitor comprising xanthan gum present at a concentration of 0.05 to 2.0 percent by weight of the pre-wetting composition. The liquid pre-wetting composition also optionally includes a radiation absorber comprising present at a concentration of 0.05 to 1.0 percent by weight of the pre-wetting composition. The deicer composition also includes a deicing salt. The deicing salt includes sodium chloride rock salt present at a concentration of 65 to 90 percent by weight of the deicer composition. The deicing salt also includes magnesium chloride hydrate present at a concentration of 1.0 to 25 percent by weight of the deicer composition. The deicing salt also includes a second corrosion inhibitor comprising diammonium phosphate present at a concentration of 0.5 to 5.0 percent by weight of the deicer composition.

### DETAILED DESCRIPTION

### Selected Definitions

As used in this disclosure, the following terms shall have the following meanings:

The term “anti-icing” refers to the application of a deicer composition to a pavement before a winter precipitation event occurs.

The term “corrosion inhibitor” as used in this disclosure is a compound added to or is a part of a deicer composition to reduce the corrosion of metals, and particularly to mild steel.

The term “deicer composition” as used in this disclosure is a compound used to melt snow or ice by depressing the freezing point of water, or to prevent snow or ice from bonding to a surface. A deicer composition may include a liquid deicing composition, a pre-wetting composition, a deicer, an anti-icer, or a pre-wetted deicer.

The term “deicing” refers to the application of a chemical to an existing accumulation of snow or ice on a pavement surface.

The term “leaching inhibitor” as used in this disclosure is a compound added to or mixed with a liquid deicing salt to reduce leaching or the migration of liquid out of a mass of pre-wetted deicer.

The term “liquid bittern” as used in this disclosure is a product derived from sea salt production, and is the liquid remaining after the substantial pre-removal of sodium chloride from sea water. Liquid bittern usually contains water along with a high concentration of magnesium chloride and lower concentrations of other salts.

The term “liquid deicing salt” also referred to as a liquid deicer, as used in this disclosure is an aqueous solution of a deicing salt.

The term “pre-wetted deicer” as used in this disclosure is a solid deicing salt treated with a liquid pre-wetting composition prior to application to a surface. A pre-wetted deicer is sometimes referred to in the industry as a treated salt.

The term “pre-wetting” refers to the application of a liquid pre-wetting composition to a solid deicing salt such as solid rock salt before it is applied to pavement.

The term “pre-wetting composition” as used in this disclosure is an aqueous solution of a compound or a mixture of compounds, such as a liquid deicing salt, which may be added to a solid deicing salt.

### Deicer Compositions

In one aspect of the disclosure, the deicer composition comprises a pre-wetting composition and a solid deicing salt. The pre-wetting composition includes a deicing salt, a corrosion inhibitor, a leaching inhibitor, and water. The deicing salt of the pre-wetting composition may include a deicing salt such as urea or a sodium, potassium, magnesium, calcium or ammonium salt of chloride, carbonate, lactate, succinate, acetate, propionate, formate, and combinations thereof including sodium chloride, magnesium chloride, calcium chloride, potassium chloride, potassium carbonate, urea, sodium acetate, potassium acetate, ammonium acetate, calcium magnesium acetate, sodium formate, potassium formate, potassium lactate, sodium lactate, sodium succinate, potassium succinate and combinations thereof. The corrosion inhibitor of the pre-wetting composition may include at least one aldonic or aldaric acid or salt of an aldonic or aldaric acid chosen from D-erythronic acid, D-gulonic acid, glucaric acid, gluconic acid, L-mannonic acid, and combinations thereof. The leaching inhibitor of the pre-wetting composition may include at least one of soy flour, dextrin, starch, a gum including, gum Arabic, guar gum, xanthan gum, gum ghatti, gum karaya, locust bean gum, and carageenan gum, sodium alginate, partially hydrolyzed polyacrylamide, bentonite, attapulgite, montmorillonite, hectorite, kaolin, hydroxyethylcellulose, and other leaching inhibitors, such as viscosifying and thixotropic clays. The solid deicing salt includes a deicing salt and a corrosion inhibitor. The deicing salt of the solid deicing salt may include sodium, potassium, magnesium, calcium or ammonium salt of chloride, and combinations thereof, including sodium chloride, magnesium chloride, calcium chloride, potassium chloride, magnesium chloride hydrates, calcium chloride hydrates, and combinations thereof. The corrosion inhibitor of the solid deicing salt may include phosphate salts, such as orthophosphates, polyphosphates, pyrophosphates, and organic phosphates, diammonium phosphate, monosodium phosphate, and calcium or magnesium phosphates.

In another aspect of the disclosure, the deicer composition comprises a pre-wetting composition and a solid deicing salt. The pre-wetting composition includes a deicing salt, a corrosion inhibitor, a leaching inhibitor, and water. The solid deicing salt includes a deicing salt and a corrosion inhibitor. The deicing salt of the pre-wetting composition is present at a concentration of 0.1-75.0 percent by weight of the pre-wetting composition. In another aspect of the disclosure, the deicing salt of the pre-wetting composition is present at a concentration of 0.2-50.0 percent by weight of the pre-wetting composition. In another aspect of the disclosure, the deicing salt of the pre-wetting composition is present at a concentration of 0.3-30.0 percent by weight of the pre-wetting composition. In another aspect of the disclosure, the deicing salt of the pre-wetting composition is present at a concentration of 0.4-29.0 percent by weight of the pre-wetting composition. In another aspect of the disclosure, the deicing salt of the pre-wetting composition is present at a concentration of 0.5-25.0 percent by weight of the pre-wetting composition. In another aspect of the disclosure, the deicing salt of the pre-wetting composition is present at a concentration of 15.0-30.0 percent by weight of the pre-wetting composition. In another aspect of the disclosure, the deicing salt of the pre-wetting composition is present at a concentration of 20.0-30.0 percent by weight of the pre-wetting composition.

In another aspect of the disclosure, the deicer composition comprises a pre-wetting composition and a solid deicing salt. The pre-wetting composition includes a deicing salt, a corrosion inhibitor, a leaching inhibitor, and water. The solid deicing salt includes a deicing salt and a corrosion inhibitor. The corrosion inhibitor of the pre-wetting composition may be present at a concentration of 0.1-25.0 percent by weight of the pre-wetting composition. In another aspect of the disclosure, the corrosion inhibitor of the pre-wetting composition is present at a concentration of 0.2-10.0 percent by weight of the pre-wetting composition. In another aspect of the disclosure, the corrosion inhibitor of the pre-wetting composition is present at a concentration of 0.3-5.0 percent by weight of the pre-wetting composition. In another aspect of the disclosure, the corrosion inhibitor of the pre-wetting composition may be present at a concentration of 0.4-3.0 percent by weight of the pre-wetting composition. In another aspect of the disclosure, the corrosion inhibitor of the pre-wetting composition may be present at a concentration of 0.5-1.0 percent by weight of the pre-wetting composition. In another aspect of the disclosure, the corrosion inhibitor of the pre-wetting composition may be present at a concentration of 0.3-1.5 percent by weight of the pre-wetting composition. In another aspect of the disclosure, the corrosion inhibitor of the pre-wetting composition may be present at a concentration of 0.1-1.0 percent by weight of the pre-wetting composition.

In another aspect of the disclosure, the deicer composition comprises a pre-wetting composition and a solid deicing salt. The pre-wetting composition includes a deicing salt, a corrosion inhibitor, a leaching inhibitor, and water. The solid deicing salt includes a deicing salt and a corrosion inhibitor. The leaching inhibitor of the pre-wetting composition is present at a concentration of 0.05-25.0 percent by weight of the pre-wetting composition. In another aspect of the disclosure, the leaching inhibitor of the pre-wetting composition is present at a concentration of 0.1-10.0 percent by weight of the pre-wetting composition. In another aspect of the disclosure, the leaching inhibitor of the pre-wetting composition is present at a concentration of 0.15-5.0 percent by weight of the pre-wetting composition. In another aspect of the disclosure, the leaching inhibitor of the pre-wetting composition is present at a concentration of 0.2-3.0 percent by weight of the pre-wetting composition. In another aspect of the disclosure, the leaching inhibitor of the pre-wetting composition is present at a concentration of 0.20-0.40 percent by weight of the pre-wetting composition. In another aspect of the disclosure, leaching inhibitor of the pre-wetting composition is present at a concentration of 0.2-0.30 percent by weight of the pre-wetting composition. In another aspect of the disclosure, the pre-wetting composition is capable of reducing corrosion of mild steel by at least 70%, as compared to a 3% solution of sodium chloride devoid of the corrosion inhibitor as measured by NACE Standard TM0169-95 as modified by the Pacific Northwest States and outlined in the 2010 Pacific Northwest Snowfighters Snow And Ice Control Chemical Products Specifications And Test Protocols For The PNS Association Of British Columbia, Colorado, Idaho, Montana, Oregon and Washington. In another aspect of the disclosure, the leaching inhibitor is present in an amount sufficient to provide a Brookfield viscosity of the pre-wetting composition between 100 and 10,000 centipoise at 25 degrees Celsius using a spindle speed of 20 RPM.

In another aspect of the disclosure, the deicer composition comprises a pre-wetting composition and a solid deicing salt. The pre-wetting composition includes a deicing salt, a corrosion inhibitor, a leaching inhibitor, and water. The solid deicing salt includes a deicing salt and a corrosion inhibitor. The pre-wetting composition is present at a concentration of 0.05-30.00 percent by weight of the deicer composition. In another aspect of the disclosure, the pre-wetting composition is present at a concentration of 1.0-10.0 percent by weight of the deicer composition. In another aspect of the disclosure the pre-wetting composition is present at a concentration of 2.0-7.0 percent by weight of the deicer composition. In another aspect of the disclosure, the pre-wetting composition is present at a concentration of 3.0-5.0 percent by weight of the deicer composition. In another aspect of the disclosure, the pre-wetting composition is present at a concentration of 4.0-5.0 percent by weight of the deicer composition. In another aspect of the disclosure, the pre-wetting composition is present at a concentration of 4.0-5.0 percent by weight of the deicer composition.

In another aspect of the disclosure, the deicer composition comprises a pre-wetting composition and a solid deicing salt. The pre-wetting composition includes a deicing salt, a corrosion inhibitor, a leaching inhibitor, and water. The solid deicing salt includes a deicing salt and a corrosion inhibitor. The solid deicing salt may be present at a concentration of 60.0-99.5 percent by weight of the deicer composition. In another aspect of the disclosure, the solid deicing salt is present at a concentration of 70.0-99.5 percent by weight of the deicer composition. In another aspect of the disclosure, the solid deicing salt is present at a concentration of 80.0-99.5 percent by weight of the deicer composition. In another aspect of the disclosure, the solid deicing salt is present at a concentration of 90.0-99.5 percent by weight of the deicer composition.

In another aspect of the disclosure, the deicer composition comprises a pre-wetting composition and a solid deicing salt. The pre-wetting composition includes a deicing salt, a corrosion inhibitor, a leaching inhibitor, and water. The solid deicing salt includes a deicing salt and a corrosion inhibitor. The deicing salt of the solid deicing salt includes sodium chloride and magnesium chloride hydrate. In one aspect of the disclosure, the sodium chloride is present at a concentration of 0.1-95.0 percent by weight of the total deicer composition, and the magnesium chloride hydrate is present at a concentration of 0.1-95.0 percent by weight of the deicer composition. In another aspect of the disclosure, the sodium chloride is present at a concentration of 1-94 percent by weight of the total deicer composition, and the magnesium chloride hydrate is present at a concentration of 1-75 percent by weight of the deicer composition. In another aspect of the disclosure, the sodium chloride is present at a concentration of 50-93 percent by weight of the total deicer composition, and the magnesium chloride hydrate is present at a concentration of 2-50 percent by weight of the deicer composition. In another aspect of the disclosure, the sodium chloride is present at a concentration of 75-92 percent by weight of the total deicer composition, and the magnesium chloride hydrate is present at a concentration of 3-25 percent by weight of the deicer composition. In another aspect of the disclosure, the sodium chloride is present at a concentration of 85-91 percent by weight of the total deicer composition, and the magnesium chloride hydrate is present at a concentration of 4-10 percent by weight of the deicer composition. In another aspect of the disclosure, the sodium chloride is present at a concentration of 88-91 percent by weight of the total deicer composition, and the magnesium chloride hydrate is present at a concentration of 2-5 percent by weight of the deicer composition.

In another aspect of the disclosure, the deicer composition comprises a pre-wetting composition and a solid deicing salt. The pre-wetting composition includes a deicing salt, a corrosion inhibitor, a leaching inhibitor, and water. The solid deicing salt includes a deicing salt and a corrosion inhibitor. The corrosion inhibitor of the solid deicing salt may be present at a concentration of 0.1-10.0 percent by weight of the deicer composition. In another aspect of the disclosure, the corrosion inhibitor of the solid deicing salt is present at a concentration of 0.5-5.0 percent by weight of the deicer composition. In another aspect of the disclosure, the corrosion inhibitor of the solid deicing salt is present at a concentration of 1.0-4.0 percent by weight of the deicer composition. In another aspect of the disclosure, the corrosion inhibitor of the solid deicing salt is present at a concentration of 2.0-3.0 percent by weight of the deicer composition. In another aspect of the disclosure, the corrosion inhibitor of the solid deicing salt is present at a concentration of 2.0-2.5 percent by weight of the deicer composition. In another aspect of the disclosure, the deicer composition is capable of reducing corrosion of mild steel by at least 70%, as compared to a 3% solution of sodium chloride devoid of the corrosion inhibitor as measured by NACE Standard TM0169-95 as modified by the Pacific Northwest States and outlined in the 2010 Pacific Northwest Snowfighters Snow And Ice Control Chemical Products Specifications And Test Protocols For The PNS Association Of British Columbia, Colorado, Idaho, Montana, Oregon And Washington.

In another aspect of the disclosure, the deicer composition includes a pre-wetting composition and a solid deicing salt. The pre-wetting composition is present at a concentration of 1.0 to 10.0 percent by weight of the deicer composition. The pre-wetting composition includes a deicing salt, a corrosion inhibitor, a leaching inhibitor, water, and optionally a radiation absorber. The deicing salt includes a deicing salt comprising magnesium chloride present at a concentration of 10 to 35 percent by weight of the pre-wetting composition. The corrosion inhibitor of the pre-wetting composition includes sodium gluconate present at a concentration of 0.1 to 5.0 percent by weight of the pre-wetting composition. The leaching inhibitor of the pre-wetting composition includes xanthan gum present at a concentration of 0.05 to 2.0 percent by weight of the pre-wetting composition. The radiation absorber includes a colorant or dye present at a concentration of 0.05 to 1.0 percent by weight of the pre-wetting composition. The solid deicing salt includes a first solid deicing salt including sodium chloride present at a concentration of 65 to 90 percent by weight of the deicer composition. The solid deicing salt also includes a second solid deicing salt including magnesium chloride hydrate present at a concentration of 1.0 to 25 percent by weight of the deicer composition. The solid deicing salt also includes a solid corrosion inhibitor including diammonium phosphate present at a concentration of 0.5 to 5.0 percent by weight of the deicer composition.

### Deicing Salts—Solids

Deicing salts may include chloride salts, such as sodium chloride, calcium chloride magnesium chloride, potassium chloride, ammonium chloride, and combinations thereof. Deicing salts may include formate salts, such as sodium formate, calcium formate, etc. and combinations thereof. Deicing salts may include acetate salts, such as sodium acetate, potassium acetate, ammonium acetate, calcium magnesium acetate, etc., and combinations thereof. Deicing salts may also include a sodium, potassium, magnesium, calcium or ammonium salt of chloride, carbonate, lactate, succinate, acetate, propionate, formate, or combinations thereof. Deicing salts may also include, potassium carbonate, potassium lactate, sodium lactate, sodium succinate, potassium succinate and combinations thereof. Liquid bittern may also be used as a deicing salt. Deicing salts may also include urea. The deicing salt may include chloride salt that is hydrated. For example, the deicing salt may include magnesium chloride hydrate, which refers to a solid magnesium chloride containing waters of hydration of the type commonly used in solid deicer formulations. Most commonly there are 6 waters of hydration for every one MgCl₂, although magnesium chloride with different hydration numbers may be used as well. Examples of deicing salts include, but are not limited to, sodium chloride, magnesium chloride, calcium chloride, potassium chloride, potassium carbonate, urea, sodium acetate, potassium acetate, ammonium acetate, calcium magnesium acetate, sodium formate, potassium formate, potassium lactate, sodium lactate, sodium succinate, potassium succinate and combinations thereof. The most commonly used solid deicing salt is sodium chloride, which is mined as rock salt, but can also include salts collected from brines such as sea water, underground saltwater sources, or salt water lakes.

### Deicing Salts—Liquids

A liquid deicing salt can be a mixture of water and a deicing salt. The liquid deicing salt may be used as a deicer, as an anti-icer, or it may be used as a pre-wetting composition when mixed with a solid deicing salt to form a pre-wetted deicer. The liquid deicing salt of the deicer composition is a substance having at least one component such as a deicing salt which, when combined with ice, will depress the freezing point of the water permitting it to melt snow or ice at lower temperatures. For example, sodium chloride can depress the freezing point of water to as low as −21.2 degrees Celsius. Liquid bittern may also be used as a liquid deicing salt. In one aspect of the disclosure, the liquid bittern contains between about 20 and about 35 percent by weight magnesium chloride. Liquid bittern containing other concentrations, such as less than about 20 percent by weight magnesium chloride, are also suitable.

### Corrosion Inhibitor—Solid

Conventional sodium chloride road salt may be corrosive to metals in highway structures. Accordingly, the deicer composition includes a corrosion inhibitor (or anti-corrosive agent). Suitable corrosion inhibitors may include phosphate salts, such as orthophosphates, polyphosphates, pyrophosphates, and organic phosphates, diammonium phosphate, monosodium phosphate, and magnesium or calcium phosphates. Diammonium phosphate (DAP) is a preferred corrosion inhibitor. The chemical formula for DAP is (NH₄)₂HPO₄, IUPAC name diammonium hydrogen phosphate. These corrosion inhibitors are typically provided in solid form due to their relatively low solubility.

The corrosion inhibitor of the deicer composition is capable of reducing corrosion of mild steel by at least 70%, as compared to a 3% solution of sodium chloride devoid of the corrosion inhibitor as measured by NACE Standard TM0169-95 as modified by the Pacific Northwest States and outlined in the 2010 Pacific Northwest Snowfighters Snow And Ice Control Chemical Products Specifications And Test Protocols For The PNS Association Of British Columbia, Colorado, Idaho, Montana, Oregon and Washington.

### Corrosion Inhibitor—Liquid

Corrosion inhibitors for the pre-wetting composition have a suitable solubility in water. Such corrosion inhibitors include gluconic acid, glucaric acid, gluconate salts, and glucarate salts.

### Leaching Inhibitor

Some liquid components may leach out of the deicer composition. Accordingly, suitable leaching inhibitors include gums such as xanthan gum, cellulose gum, gum Arabic, guar gum, xanthan gum, gum ghatti, gum karaya, locust bean gum, and carageenan gum, polyvinyl pyrrolidone, acrylic acid polymers, cross linked acrylic polymers, polyether polyols, sodium carboxym ethyl cellulose, hydroxyethyl cellulose, carboxymethyl hydroxypropyl guar, hydroxypropyl guar, polyanionic cellulose, pregelatinized crosslinked starch such as hydroxypropyl distarch phosphate and distarch phosphate, scleroglucan, pectin, soy flour, dextrin, starch, sodium alginate, partially hydrolyzed polyacrylamide, bentonite, attapulgite, montmorillonite, hectorite, kaolin, and other leaching inhibitors, such as viscosifying and thixotropic clays, and combinations thereof. The leaching inhibitor may be a viscosifying additive such as a compound added to or mixed with a liquid deicing salt to increase its viscosity.

### Performance Enhancers

The deicer compositions can optionally include a radiation absorber. Radiation absorbers include chemicals with a high molar absorptivity in the infra-red, visible and/or ultraviolet portions of the spectrum, thereby efficiently converting absorbed solar radiation to heat. Compounds of this type include certain colorants and dyes.

In one aspect of the disclosure, Naphthol Green B dye may be used as a radiation absorber in accordance with the present disclosure. Examples of other radiation absorbers include Liquitint© Green HMC, Liquitint© Patent Blue, Liquitint® Yellow LP (available from Milliken Chemical, Spartanburg, S.C.), Emerald Green Liquid (available from Sensient Technologies, Milwaukee, Wis.), FD&C Blue 1, FD&C Yellow 5, FD&C Red 40, or combinations thereof. In one aspect of the disclosure where the radiation absorber is added to the liquid deicer composition, the radiation absorber is present in an amount of between about 0.02% and about 0.50% by weight. In another aspect of the disclosure where the radiation absorber is added to the deicer composition further comprising a solid deicing salt, the radiation absorber is present in an amount of between about 0.001% to about 0.02% by weight. In another aspect of the disclosure, a combination of FDC Blue 1, FDC Yellow 5, and FDC Red 40 is suitable for use as a radiation absorber (available as “Green Blend 1 137” from Rainbow Specialty Colors, Inc.).

### EXAMPLES

Aspects of the invention are illustrated in the following examples.

### Example 1

A deicer composition was produced at a commercial manufacturing facility. The deicer composition included a pre-wetting composition and a solid composition. The pre-wetting composition included a deicing salt, a corrosion inhibitor, a leaching inhibitor, and water. The solid deicing salt includes a deicing salts and a corrosion inhibitor. The components of the deicer composition were combined in the following amounts:
(i) pre-wetting composition: 26% MgCl₂, 0.27% xanthan gum, 0.26% blend of FD&C Blue 1, FD&C Yellow 5, and FD&C Red 40, and 0.3% sodium gluconate, collectively 4.1 parts by weight;
(ii) solid composition salt #1: NaCl 89.70 parts by weight;
(iii) solid composition salt #2: MgCl₂ hexahydrate 4.0 parts by weight;
(iv) solid composition corrosion inhibitor diammonium phosphate: 2.20 parts by weight.

### Example 2

Six formulations of a deicer composition were produced having the formulations as shown in Table 1. Corrosion tests were run according to the following procedure: The test coupons used were ASTM F 436, Type 1 flat steel washers with approximate dimensions 1.38 in. outer diameter, 0.56 in. inner diameter, and 0.1 1 in. thick with a density of approximately 7.85 grams per cubic centimeter and a Rockwell Hardness of C 38-45; coupons were wiped with hexane to remove grease and oil and then acetone rinsed; the coupons were removed from the acetone, allowed to air dry and then weighed to the nearest 0.1 mg.

3.0% by weight solutions of each deicer composition were prepared in 18 Megohm deionized water, and approximately 276 mL of each deicer solution was put into a 500 milliliter Erlenmeyer flask. In each of the formulas in Table 1, the pre-wetting liquid had a solution of 26% MgCl₂, 0.27% xanthan gum, 0.26% blend of FD&C Blue 1, FD&C Yellow 5, and FD&C Red 40, and 0.3% sodium gluconate. Each flask was equipped with a rubber stopper drilled to allow a line to run through it. Three coupons were mounted in a plastic holder and suspended inside the flask through the stopper hole. A timed device raised and lowered the test coupons so they were completely immersed in the test solutions for 10 minutes and then raised so they were suspended within the flask and above the test solution for 50 minutes. This cycle was repeated for 72 hours. Tests were conducted at room temperature. At the end of the exposure period the coupons were removed from the test solutions and scrubbed with a nylon brush under running water to remove coarse corrosion products. They were then immersed in a cleaning solution of approximately 3.8% hydrochloric acid and 0.1% Rodine 213 in warm tap water for approximately 20 minutes. The coupons were then removed, scrubbed again with a nylon brush under running water, immersed in an acetone bath and allowed to air dry. The coupons were then re-weighed to the nearest 0.1 mg. Fresh coupons not exposed to the test solutions were also taken through the same cleaning procedure to determine the weight loss due to the cleaning process. The weight loss due to cleaning was subtracted from the total weight loss of the test coupons to determine the actual corrosion weight loss. The percent reduction in corrosion rate compared to salt is calculated as follows: % Reduction in Salt Induced Corrosion=(weight loss of salt control−weight loss of test sample)/(weight loss of salt control−weight loss of water control)×100. Thus, pure water will have a corrosion reduction of 100%, and the salt control will have a corrosion reduction of 0%. This provides a relative comparison of the corrosiveness of various test formulas compared to deionized water and 3% sodium chloride.

As can be seen in Table 1, the corrosion inhibition observed when the only corrosion inhibitor present was in the pre-wetting liquid component is the first formulation having a 24.7% reduction in salt induced corrosion. This is not sufficient to meet a common deicer corrosion specification of an at least 70% reduction in corrosion. However, the examples show the addition of various ratios of magnesium chloride hexahydrate and diammonium phosphate to the solid deicer component results in a substantial increase in corrosion protection and, depending on the formula, can exceed 70% corrosion reduction. These compositions have the unique advantage that they can be “tuned.” There is a synergistic corrosion inhibiting interaction between the magnesium chloride hydrate and the diammonium phosphate in these formulas such that lower diammonium phosphate levels can be used to achieve a given corrosion protection value if higher magnesium chloride hydrate levels are present, and vice versa. Magnesium chloride hydrate also provides enhanced ice melting performance at colder temperatures, so depending on the relative importance of performance characteristics desired (low temperature ice melting performance versus corrosion inhibition) this formula permits a unique ability to be “tuned” or optimized to provide a desired level of ice melting performance and corrosion inhibition at minimized cost.

TABLE 1

| | % Reduction in Salt |
|---|---|
| Formula | Induced Corrosion |
| 9.68% MgCl₂•6H₂O, 4.1% | 24.7 |
| pre-wetting liquid, 86.22% NaCl | |
| 3.75% DAP, 4.1% | 75.9 |
| pre-wetting liquid, 92.15% NaCl | |
| 8.0% MgCl₂•6H₂O, 0.65% DAP, 4.1% | 53.2 |
| pre-wetting liquid, 87.25% NaCl | |
| 6.0% MgCl₂•6H₂O, 1.43% DAP, 4.1% | 64.6 |
| pre-wetting liquid, 88.47% NaCl | |
| 4.0% MgCl₂•6H₂O, 2.20% DAP, 4.1% | 73.4 |
| pre-wetting liquid, 89.70% NaCl | |
| 2.0% MgCl₂•6H₂O, 2.98% DAP, 4.1% | 75.5 |
| pre-wetting liquid, 90.92% NaCl | |

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. When the claims use the word “or” in reference to a list of two or more items, that word covers all of the following interpretations of the word: any of the items in the list, all of the items in the list, and any combination of the items in the list.

The above detailed descriptions of embodiments of the invention and aspects of the disclosure are not intended to be exhaustive or to limit the invention to the precise form disclosed above. Although specific embodiments of, and examples for, and aspects of the disclosure of, the invention are described above for illustrative purposes, various equivalent modifications are possible within the scope of the invention, as those skilled in the relevant art will recognize. For example, while steps are presented in a given order, alternative embodiments and aspects of the disclosure may perform steps in a different order. The various embodiments and aspect described in this disclosure can also be combined to provide further embodiments and aspects.

In general, the terms used in the following claims should not be construed to limit the invention to the specific embodiments disclosed in the specification, unless the above detailed description explicitly defines such terms. While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

1. A deicer composition, comprising:
a pre-wetting composition, comprising:
a liquid deicing salt;
a liquid corrosion inhibitor comprising at least one aldonic or aldaric acid or salt of an aldonic or aldaric acid chosen from D-erythronic acid, D-gulonic acid, glucaric acid, gluconic acid and L-mannonic acid; and
a liquid leaching inhibitor comprising at least one of soy flour, dextrin, starch, gum Arabic, guar gum, xanthan gum, gum ghatti, gum karaya, locust bean gum, carageenan gum, sodium alginate, partially hydrolyzed polyacrylamide, bentonite, attapulgite, montmorillonite, hectorite, kaolin, hydroxyethylcellulose, viscosifying, clays; and
a solid composition, comprising:
a solid deicing salt;
a solid corrosion inhibitor comprising a phosphate salt.

2. The deicer composition of claim 1, wherein the liquid deicing salt and the solid deicing salt consists essentially of a chloride salt.

3. The deicer composition of claim 2, wherein the liquid deicing salt is present at a concentration of 0.1-75.0 percent by weight of the pre-wetting composition.

4. The deicer composition of claim 2, wherein the corrosion inhibitor of the pre-wetting composition is sodium gluconate.

5. The deicer composition claim 4, wherein the liquid corrosion inhibitor is present at a concentration of 0.1-25.0 percent by weight of the pre-wetting composition.

6. The deicer composition of claim 2, wherein the liquid leaching inhibitor is present at a concentration of 0.05-25.00 percent by weight of the pre-wetting composition.

7. The deicer composition of claim 6, further comprising a radiation absorber comprising a colorant.

8. The deicer composition of claim 7, wherein the radiation absorber is present at a concentration of 0.05-5.00 percent by weight of the pre-wetting composition.

9. The deicer composition of claim 8, wherein the pre-wetting composition is present at a concentration of 0.5-30.0 percent by weight of the deicer composition.

10. The deicer composition of claim 9, wherein the solid deicing salt comprises sodium chloride present at a concentration of 0.1-95.0 percent by weight of the total deicer composition, and magnesium chloride hydrate present at a concentration of 0.1-95.0 percent by weight of the deicer composition.

11. The deicer composition of claim 10, wherein the solid corrosion inhibitor comprises diammonium phosphate present at a concentration of 0.1-10 percent by weight of the deicer composition.

12. The deicer composition of claim 11, wherein the solid deicing salt is present at a concentration of 60.0-99.5 percent by weight of the deicer composition.

13. The deicer composition of claim 12, wherein the deicer composition is capable of reducing corrosion of mild steel by at least 70%, as compared to a 3% solution of sodium chloride devoid of the corrosion inhibitor.

14. The deicer composition of claim 1, wherein the wherein the liquid leaching inhibitor is present in an amount sufficient to provide a Brookfield viscosity of the pre-wetting composition between 100 and 10,000 centipoise at 25 degrees Celsius using a spindle speed of 20 RPM.

15. A deicer composition, comprising:
a liquid pre-wetting composition present at a concentration of 1.0 to 10.0 percent by weight of the deicer composition, comprising:
a deicing salt comprising magnesium chloride present at a concentration of 10 to 35 percent by weight of the pre-wetting composition;
a corrosion inhibitor comprising sodium gluconate present at a concentration of 0.1 to 5.0 percent by weight of the pre-wetting composition; and
a leaching inhibitor comprising xanthan gum present at a concentration of 0.05 to 2.0 percent by weight of the pre-wetting composition;
optionally a radiation absorber comprising present at a concentration of 0.05 to 1.0 percent by weight of the pre-wetting composition; and
a solid deicing salt comprising:
a first solid deicing salt comprising sodium chloride present at a concentration of 65 to 90 percent by weight of the deicer composition;
a second solid deicing salt comprising magnesium chloride hydrate present at a concentration of 1.0 to 25 percent by weight of the deicer composition;
a solid corrosion inhibitor comprising diammonium phosphate present at a concentration of 0.5 to 5.0 percent by weight of the deicer composition.

16. A deicer mixture, comprising:
a liquid pre-wetting composition present at a concentration of 1.0 to 10.0 percent by weight of the deicer composition, comprising:
a deicing salt comprising magnesium chloride present at a concentration of 10 to 35 percent by weight of the pre-wetting composition;
a first corrosion inhibitor comprising sodium gluconate present at a concentration of 0.1 to 5.0 percent by weight of the pre-wetting composition; and
a leaching inhibitor comprising xanthan gum present at a concentration of 0.05 to 2.0 percent by weight of the pre-wetting composition;
optionally a radiation absorber comprising present at a concentration of 0.05 to 1.0 percent by weight of the pre-wetting composition; and
a deicing salt comprising:
sodium chloride rock salt present at a concentration of 65 to 90 percent by weight of the deicer composition;
magnesium chloride hydrate present at a concentration of 1.0 to 25 percent by weight of the deicer composition;
a second corrosion inhibitor comprising diammonium phosphate present at a concentration of 0.5 to 5.0 percent by weight of the deicer composition.
